(19) United States
(12) Patent Application Publication
(10) Pub. No.: US 2007/0061592 A1
(43) Pub. Date: Mar. 15, 2007

(54) Computer input device with security protection and method thereof

(76) Inventor: Zhi-Heng Nian, San Chung City (TW)

Correspondence Address: RABIN & Berdo, PC, 1101 14TH STREET, NW, SUITE 500, WASHINGTON, DC, 20005, US

(21) Appl. No.: 11/224,987

(22) Filed: Sep. 14, 2005

(51) Int. Cl. G06F 12/14

(52) U.S. Cl. 713/189

(57) ABSTRACT

A computer input device with security protection and method thereof is provided, wherein a security protection enable key is set on the input device of the computer, and the security protection program residing in the memory is started by triggering the security protection enable key, and thereby any signal from all the external input devices is intercepted so that the personal computer immediately enters into the state of security protection and promptly releases the blocking for the security protection by inputting the combined signals.

### BACKGROUND OF THE INVENTION

1. Field of Invention

The present invention relates to a computer input device with security protection and method thereof, and in particular, to a system and method for intercepting the input signals transmitted to the operating system from the input device, so as to keep these signals from being executed by the operating system.

2. Related Art

In recent years, due to the increasing processing speed of the central processing unit (CPU) under Moore's Law, the operating systems have also been constantly innovated and developed as the hardware being changed, for example, the strengthening of the hardware support and the enhanced processing effect of the multimedia etc. However, since there are many different function objects in one operating system, it is likely that security holes are left in the immature product that is published in a rush.

The security holes may affect the performance of the whole system, or more seriously, the data stored in the computer may be damaged or invaded, which causes secret data to be stolen. Therefore, both the operating system manufacturers and the application software manufacturers cared much about this. For example, to prevent the file data being peeped or damaged or a mail being sent in the user's name by a furtive person deliberately when the user himself is away from the computer, the display panel can be locked through executing the screensaver program, and unlocked by entering the preset password when the user is back.

However this method takes effect only when the screensaver program is started. Although the function could also be achieved under the screensaver preview mode, multiple steps have to be gone over to select the screensaver preview mode to realize the function of the screensaver preview, which is very inconvenient.

Another method is to employ a stand-by mode, such as the disclosure in U.S. Pat. No. 6,741,455 “Folding Keyboard with Automatic State Initiator” (published on 25 May 2004 AD), in which a sleep mode or wake mode provided by the OS (operating system) can be entered quickly through pressing the keys of the keyboard, and in ROC Patent Publication No. 323349 “Circuit for Controlling Computer Power System through Keyboard” (published on 21 Dec. 1997), in which the computer power system can be controlled through the keyboard by means of pressing keys, i.e., the user can control the “ON” and “OFF” of the computer power system only by pressing keys in a predefined combination.

When the stand-by mode is activated, the operating system will keep the program, which is currently executed, in the memory with a certain electric power, and shut down the system. When the user starts the system again afterwards, he only needs to enter the password to read the program under execution from the memory, and the system will be restored to the state before the stand-by promptly. But such method may not work, since usually some of the application programs cannot be supported by the operating system to enter the stand-by mode, and therefore, the stand-by mode cannot be enabled until such application programs are shut down. Moreover, sometimes the computer is required to keep working, and the program cannot be executed in the background if the stand-by mode is entered. As such, although the security of the computer can be achieved by shutting down the system, the user has to stop the operation of the computer.

Therefore, it is a very important issue at present to seek for a method that can realize the security of the personal computer and give convenience for user's operation and meanwhile maintain the running of the computer.

### SUMMARY OF THE INVENTION

In view of the problems mentioned above, the inventor provides a computer input device with security protection and method thereof. Based on the decision made by the MCU (Micro-processor Control Unit) whether the signal transmitted from the input device is the signal for activating the security protection program, the user can immediately start the security protection program, thereby to intercept the instruction from an input device to be transmitted to the operating system, so that the operating system can keep running and be prevented from any destructions caused by the external input signals.

Therefore, for the purposes described above, the computer input device with security protection disclosed in the present invention comprises at least:

an input device, including a security protection enable key, which is a key of any input device for receiving the user's trigger to transmit the security protection enable signal;

a Micro-processor Control Unit (MCU) for determining whether the signal input from the input device is a security protection enable signal; if yes, the security protection program residing in the memory is started; and

a security protection program residing in the memory, which is loaded into the memory by the boot program of the OS (operation system) for residing in the memory when the personal computer is booted up, and starts to intercept the signal to be transmitted to the operation system from the input device after being started via the security protection enable key by the user.

For the purpose of the objects and advantages of the present invention, the method of the present invention comprises the following steps:

if an input security protection program enable signal is received, activating the security protection program having been loaded into the memory; then starting to intercept the input signal to be transmitted to the operating system from the input device, and then determining whether such signal is a security protection disable signal;

if the intercepted input signal is a security protection disable signal, terminating the signal interception action of the security protection program; otherwise, determining the type of the input signal, and then executing the input signal according to the security.

The features and implementations of the present invention will be described in detail in the preferred embodiments in conjunction with the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view of the appearance of the present invention;

FIG. 2 is a system architecture view of the present invention before the security protection program is started;

FIG. 3 is a system architecture view of the present invention after the security protection program is started;

FIG. 4 is a flow chart of the method of the present invention.

### DETAILED DESCRIPTION OF THE INVENTION

The present invention discloses a computer input device with security protection and the method thereof. Various specific details will be described in the following descriptions of the present invention so as to fully explain the present invention. However, the present invention can be implemented either without using such specific details or by alternative elements or methods for those skilled in the art. In other cases, the known methods, procedures, parts and circuits will not be described in detail so as not to blur the focus of the present invention.

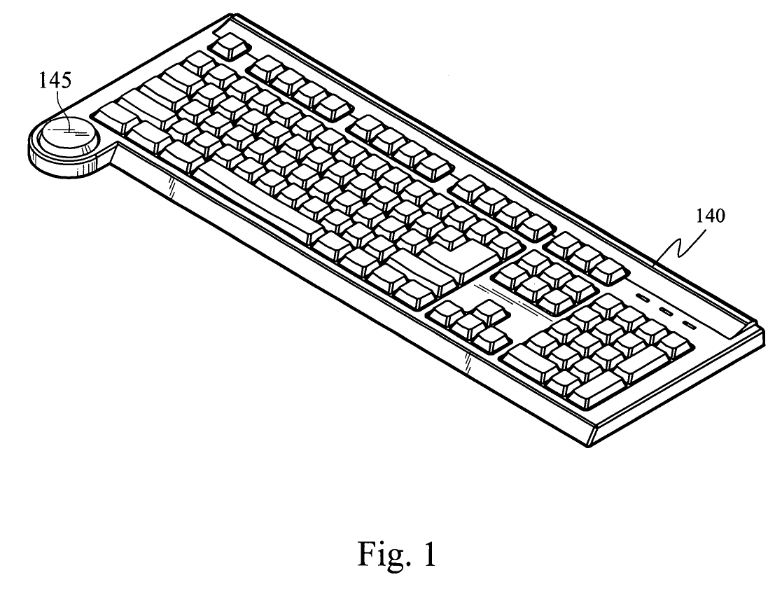

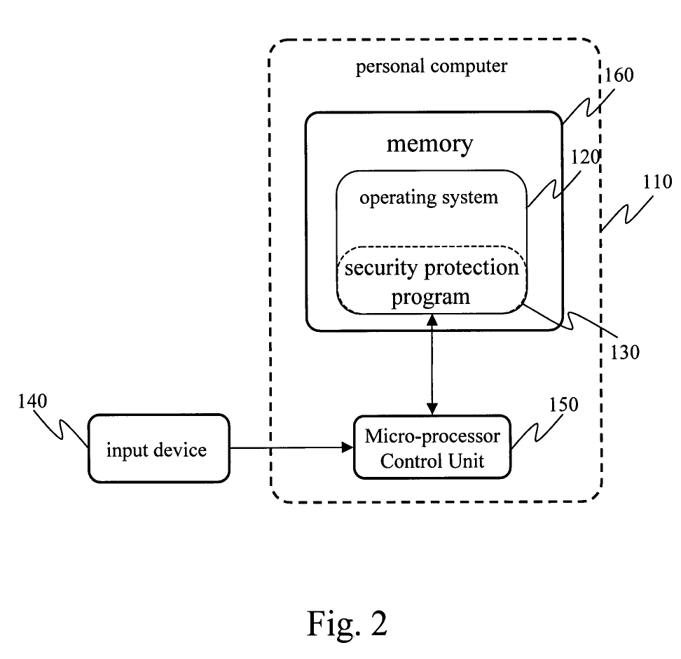

Referring to FIG. 1, which is a schematic view of the appearance of the present invention, taking a keyboard as an example, the keyboard has a security protection enable key 145; also referring to FIG.2, which is a schematic view of personal computer system architecture of the present invention. In the ordinary personal computer 110, the input device 140 includes but not limited to the conventional keyboard, mouse, track ball, digital tablet, game controller etc., for receiving the signal input by the user. The received input signal is then transmitted to a MCU 150, which determines whether the signal input from the input device 140 by the user is a security protection enable signal or not.

If it is only an ordinary input signal, it will be transmitted to the operation system of the memory 160 after being received by the MCU 150 for post processing, for example, starting an executable application, deleting a file data, modifying the system parameter, sending an E-mail, and inputting an instruction and the like.

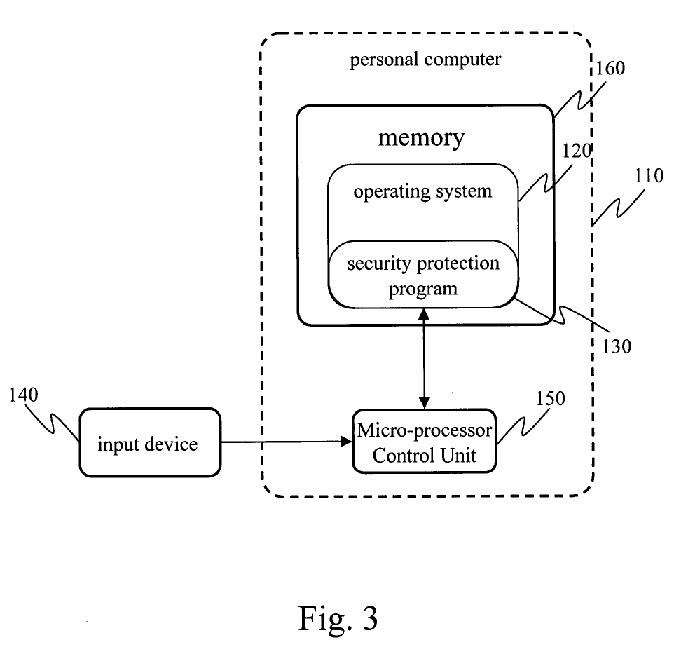

If the computer input signal is a security protection enable signal, referring to FIG. 3, which is different from FIG.2 in that the MCU 150 will start the security protection program 130 residing in the memory 160, and receive the transmitted input signal at the front end of the operating system 120; and at this time when the input device 140 is to transmit the input signal to the operating system 120, the security protection program 130 will firstly intercept the transmitted input signal, and according to the preset security level, for example, when the security level is set to lock the current screen, the pointer on the screen will be kept stationary regardless of the instruction transmitted from the mouse or keyboard, but the instruction of clicking the icon still can be executed by the operating system 120.

For a more practical application, the common security level is to block all the input signals. In this case, the security protection program 130 will intercept and discard all the transmitted input signals at the front end of the operating system 120, to protect the operating system 120 from being damaged and avoid the data being peeked. It is to be understood that when an illegal user intends to access the secret data, the user may press the security protection enable key 145 immediately to start the security protection program 130, thereby instantaneously preventing others from peeking the current using state of the computer; and when the user leaves his seat, he may press the security protection enable key 145 naturally to start the security protection program 130, while others cannot find out the current using state of the computer.

Wherein, the security protection signal may be an additionally set security protection enable key 145 for producing a particular computer input signal; or may be a combination of two or more particular keys for producing a particular combination of the computer input signals, so that the security protection program 130 residing in the memory 160 may be started, and intercept the transmitted input signal at the front end of the operating system 120.

On the other hand, when the security protection is desired to be disabled, the user may stroke a particular key or particularly combined keys to produce a particular computer input signal or particularly combined computer input signals for representing a security protection disable signal; after the security protection disable signal is identified to be true by the security protection program 130, the operating system 120 may receive the operation of the input device 140 to the computer 110. It should be noted that since the computer system at this moment is not “OFF”, the user may re-operate the input device 140 back to the prior using state of the computer, without any affect to the access and use of the secret data.

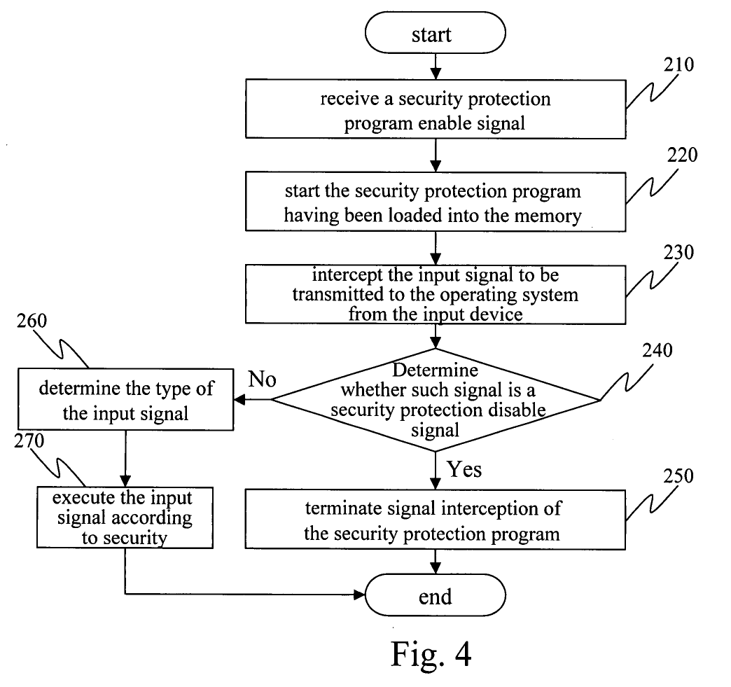

Referring to FIG. 4, it is a flow chart of the method of the present invention. First, the user inputs a security protection program enable signal from the input device 140 (Step 210), wherein said signal may be produced by triggering a particular key on the keyboard or a combination of particular keys set by the user; both the combination of the particular keys and the security protection enable signal need to be identified by the MCU 150; and then, after they are identified as the correct security protection program enable signal by the MCU 150, the security protection program 130 having been loaded into the memory 160 will be started (Step 220).

And then the security protection program 130 starts to intercept the input signal to be transmitted to the operating system 120 from the input device 140 (Step 230), and whether such signal is a security protection disable signal or not is further determined (Step 240).

If the intercepted input signal is a security protection disable signal, the signal interception action of the security protection program will be terminated (Step 250). At this moment the operating system 120 is restored to receive the input signal transmitted by the input device 140 directly; otherwise, the type of the input signal is determined (Step 260), and whether said input signal should be executed or not is determined according to security (Step 270).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer input device with security protection, comprising at least:
an input device, connected to a host; characterized in that:
the input device has at least one key, which produces at least an ordinary computer input signal and a security protection enable signal which are then transmitted to the host;
wherein the host further comprises a MCU(Micro-processor Control Unit) and a memory which is provided with a security protection program; the MCU receives the security protection enable signal to intercept any ordinary computer input signals, and the host terminates any operations of the computer input device to the host.

2. The computer input device with security protection according to claim 1, wherein the host receives a predetermined ordinary computer input signal regarded as a computer security protection disable signal, then the host can receives the computer input signals from the computer input device normally.

3. The computer input device with security protection according to claim 1, wherein the host receives a combination of at least two predetermined ordinary computer input signals regarded as a computer security protection disable signal, then the host can receives the computer input signals from the computer input device normally.

4. The computer input device with security protection according to claim 1, wherein the security protection enable signal is a specific ordinary computer input signal.

5. The computer input device with security protection according to claim 1, wherein the security protection enable signal is a combination of at least two specific ordinary computer input signals.

6. A method for security protection via a computer input device, comprising:
a host receives a security protection enable signal produced by a computer input device;
the host activates a security protection program;
the security protection program intercepts any of a plurality of ordinary computer input signals transmitted to the host from the computer input device; and
the host terminates any operation of the computer input device to the host.

7. The method for security protection by a computer input device according to claim 6, wherein when a predetermined or a combination of the ordinary computer input signals is regarded as the security protection enable signal, the security protection program is disabled in the memory such that the host retrieves the operation and receives the computer input signals coming from the computer input device normally.

8. The method for security protection by a computer input device according to claim 6, wherein the security protection enable signal is a specific ordinary computer input signal from the input device.

9. The method for security protection by a computer input device according to claim 6, wherein the security protection enable signal is at least two specific ordinary computer input signals from the input device.
